(19) United States
(12) Patent Application Publication
(10) Pub. No.: US 2004/0206117 A1
(43) Pub. Date: Oct. 21, 2004

(54) Mold for press-molding glass optical articles and method for making the mold

(76) Inventor: Ga-lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/827,762

(22) Filed: Apr. 19, 2004

(30) Foreign Application Priority Data
Apr. 18, 2003 (TW) 92109036

(51) Int. Cl. C03B 40/02

(52) U.S. Cl. 65/26; 65/374.12; 65/374.13; 65/374.15

(57) ABSTRACT

A mold (1) for press-molding glass optical articles with high precision includes a mold base (2) having a press surface, and a thin film (3) of diamond like carbon material deposited on the press surface. A thickness of the thin film is in the range from 50 to 200 angstroms. The mold base is made of a hard metallic alloy or a ceramic material. The mold does not adhere to glass material, and is resistant to oxidization. A method for making the mold is also disclosed.

### BACKGROUND OF THE INVENTION

1. Field of the Invention

The present invention relates to press-molding of glass optical articles, and more particularly to a mold for press-molding glass optical articles with high precision and a method for making such a mold.

2. Description of Prior Art

Glass optical articles, especially aspheric glass lenses, are widely used in digital cameras, video recorders, compact disc players and other optical systems due to their excellent optical performance. However, mass production manufacturing of aspheric glass lenses by conventional machining and polishing methods is widely considered to be unduly complicated, time-consuming and costly.

For these reasons, a direct press-molding method has gained in popularity in the past decade. In this method, an aspheric glass lens can be made simply by directly pressing a mass of glass material between a pair of molds under certain conditions. No further processing, such as conventional polishing, is needed. Accordingly, efficiency and production capability can be greatly increased.

The kind of material used for making the mold is an important factor in obtaining manufactured aspheric glass lenses with high precision. Criteria that should be considered in choosing the material for the mold are listed below:

a. the material should be rigid and hard enough so that the mold is not damaged by scratching and is strong enough to withstand high temperatures;

b. the material should prevent the mold from being deformed or ruptured under frequent heat shock;

c. the material does not react with glass material at high temperatures, and resists adherence of the glass material to a surface of the mold;

d. the material should resist oxidization at high temperatures; and

e. the material should enable the mold to be easily made into a desired shape with high precision and with a smooth surface.

In earlier years, stainless steel and heat resistant metallic alloys were mainly used for making molds. However, these molds typically have the following defects: crystal grains of the mold material steadily grow larger and larger over a period of time of usage, and the surface of the mold becomes rough; the mold material is apt to being oxidized at high temperatures; and the glass material adheres to the surface of the mold.

In order to resolve the above-mentioned problems, non-metallic materials and super hard metallic alloys are being used for making molds. Silicon carbide (SiC), silicon nitride (Si₃N₄), titanium carbide (TiC), tungsten carbide (WC) and a tungsten carbide-cobalt (WC-Co) metallic alloy have been reported as being used for making molds. However, SiC, Si₃N₄ and TiC are extremely high hardness ceramics, and it is very difficult to form these materials into a desired aspheric shape with high precision. Further, WC or a WC—Co alloy are liable to be oxidized at high temperatures, therefore they are not suitable for high-precision molds.

Thus combined molds composed of a matrix base and a press surface film have been developed. The matrix base is made of a hard metallic alloy or a ceramic such as WC, chromium carbide (Cr₃C₂), or aluminum oxide (Al₂O₃). The press surface film is usually a layer of SiC or Si₃N₄ formed on a press surface of the mold. This combination helps the mold to satisfy the dual requirements of high strength of the matrix and high smoothness of the press surface. However, glass material is liable to adhere to the press surface of the mold at high temperatures above 400 degrees Centigrade. This makes it difficult to separate and remove the molded glass optical articles from the mold.

### SUMMARY OF THE INVENTION

Accordingly, an object of the present invention is to provide a mold for press-molding glass optical articles with high precision, the mold having improved resistance to oxidization and enhanced chemical stability so that glass material does not adhere thereto even at high temperatures.

Another object of the present invention is to provide a method for making the above-described mold.

In order to achieve the objects set out above, a preferred mold for press-molding glass optical articles in accordance with the present invention comprises a mold base having a press surface, and a thin film of diamond like carbon material deposited on the press surface. A thickness of the thin film is in the range from 50 to 200 angstroms. The mold base is made of a material selected from the group consisting of silicon carbide (SiC), silicon (Si), silicon nitride (Si₃N₄), zirconium oxide (ZrO₂), titanium nitride (TiN), titanium oxide (TiO₂), titanium carbide (TiC), boron carbide (B₄C), tungsten carbide (WC), tungsten (W), and a tungsten carbide-cobalt (WC—Co) alloy.

A preferred method for making the mold in accordance with the preset invention comprises: providing a mold with a press surface; and depositing a thin film of diamond like carbon material onto the press surface using an RF (radio frequency) sputtering process.

The thin film of diamond like carbon material deposited on the press surface is resistant to oxidization even at high temperatures, so that the glass material to be molded does not adhere to the mold during press-molding, and the molded glass article is easy to separate from the mold. In addition, the thin film of diamond like carbon formed by the method of the present invention is a continuous thin film having improved resistance to friction or scratching, so that the thin film of diamond like carbon does not peeling off from the press surface even after much repeated use of the mold.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic side elevation of a mold having inner press layers according to a preferred embodiment of the present invention; and

FIG. 2 is a schematic diagram of an RF sputtering apparatus for forming the inner press layers of the mold of FIG. 1.

### DETAILED DESCRIPTION OF A PREFERRED EMBODIMENT OF THE INVENTION

Reference will now be made to the drawings to describe a preferred embodiment of the present invention in detail.

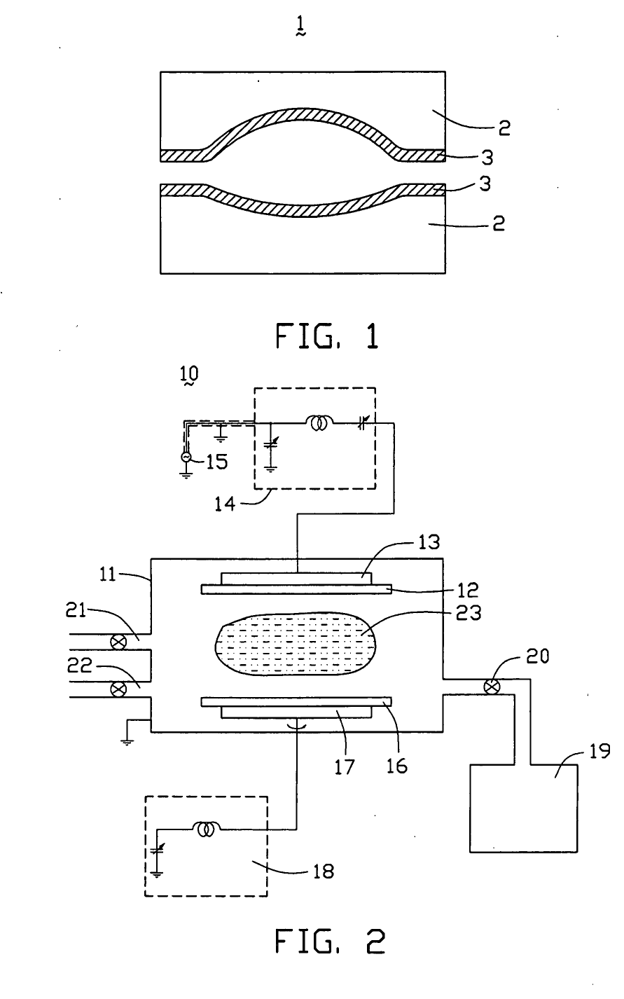

Referring initially to FIG. 1, a mold 1 for press-molding glass optical articles with high precision in accordance with the preferred embodiment of the present invention comprises a pair of half molds (not labeled) coupled to each other face-to-face. Each of the half molds comprises a mold base 2 having an inner aspheric press surface (not labeled), and a press layer 3 formed on the inner aspheric press surface.

In the preferred embodiment, the mold 1 is for press-molding aspheric glass optical articles with high precision. When the half molds are coupled with each other face-to-face, an inner space (not labeled) is defined between the two half molds for accommodating and press-molding a mass of glass material (not shown) to be molded.

The mold bases 2 can be made of a material selected from the group consisting of silicon carbide (SiC), silicon (Si), silicon nitride (Si₃N₄), zirconium oxide (ZrO₂), titanium nitride (TiN), titanium oxide (TiO₂), titanium carbide (TiC), boron carbide (B₄C), tungsten carbide (WC), tungsten (W), and a tungsten carbide-cobalt (WC—Co) alloy. The materials listed above are very hard ceramics or hard metallic alloys, and are rigid and hard enough so as not to be damaged or deformed at high temperatures.

A material of the press layer 3 of the mold 1 is diamond like carbon (DLC) material. A thickness of the press layer 3 is in the range from 50 to 200 angstroms. The DLC material is an inert material, so that the press layer 3 has the advantages of resistance to various acids, alkalis and harmful gases. In addition, the DLC material is resistant to oxidation even at high temperatures, and the press layer 3 has a high hardness and a low friction coefficient. Therefore the glass material does not readily adhere to the press layer 3, and the molded glass optical article is easily separated from the mold 1. Furthermore the mold base 2 is well protected from damage and corrosion by the press layer 3, so that a lifetime of the mold 1 is lengthened. Moreover, the press layer 3 is a continuous DLC thin film with a thickness from 50 to 200 angstroms, and has low deformation and a low stress force during press-molding. Therefore, the press layer 3 does not peel from the mold base 2 even after much repeated use of the mold 1.

A preferred method for depositing the press layer 3 of DLC material on the mold 1 by an RF sputtering process will be described in detail below with reference to FIG. 2.

Referring to FIG. 2, an RF sputtering apparatus 10 used for forming the press layer 3 comprises: a vacuum chamber 11 having two gas inlets 21, 22 and a gas outlet (not labeled) with a valve 20, the vacuum chamber 11 being grounded; a target electrode 12 comprising carbon material located near a top of the vacuum chamber 11; a magnetron sputtering gun 13 having a cathode ring (not shown) attached to the target electrode 12; an impedance matching circuit 14 electrically connected to the magnetron sputtering gun 13; an RF generator 15 electrically connected to the impedance matching circuit 14, the RF generator 15 being grounded; a holder 16 located near a bottom of the vacuum chamber 11 opposite to the target electrode 12, for holding one of the mold bases 2 (not shown in FIG. 2); an anode electrode 17 attached to the holder 16 and electrically connected with a tuning circuit 18; and a turbine pump 19 connected to the vacuum chamber 11 through the gas outlet for evacuating the vacuum chamber 11. The anode electrode 17 and the holder 16 can be rotated by a driving motor (not shown). The holder 16 includes a titanium filament heater (not shown) for heating the mold base 2 held therein.

Deposition of DLC material onto the mold base 2 for forming the press layer 3 will be described below. Prior to deposition, the mold base 2 is held by the holder 16 and heated by the titanium filament heater to a predetermined temperature, and then the driving motor is started to rotate the mold base 2. Firstly, the valve 20 is opened, and the vacuum chamber 11 is evacuated to a pressure below 10⁻⁶ torr by the turbine pump 19. Then argon gas and hydrogen, or argon gas and methane (CH₄) are introduced from the gas inlets 21 and 22, respectively, wherein a proportion of hydrogen or methane is in the range from 5% to 20% by volume. A bias voltage with a frequency of 13.56 megahertz is applied to the RF generator 15, therefore plasma 23 between the target electrode 12 and the holder 16 is produced. When the target electrode 12 is bombarded by ions in the plasma 23, carbon atoms are ejected from the target electrode 12 and deposited on the press surface of the mold base 2. A sputtering rate can be controlled to be 3.3˜8.3 angstroms per seconds. After such deposition has taken place for 6˜60 seconds, a thin film of DLC material with a thickness of 50˜200 angstroms is formed on the mold base 2. Thus the press layer 3 is obtained.

It is noted that the present invention is not limited to making aspheric glass optical articles. Other glass optical articles such as prisms are also suitable applications for the present invention. The shape of the press surfaces of the can be altered to suit the particular application according to need.

It is understood that the invention may be embodied in other forms departing from the spirit thereof. Thus, the present examples and ment are to be considered in all respects as illustrative and not restrictive, invention is not to be limited to the details given herein.

1. A mold for press-molding glass optical articles, comprising:
a mold base having a press surface; and
a thin film of diamond like carbon material deposited on the press surface of the mold base;
wherein a thickness of the thin film of diamond like carbon is in the range from 50 to 200 angstroms.

2. The mold as described in claim 1, wherein the mold base is made of a material selected from the group consisting of silicon carbide (SiC), silicon (Si), silicon nitride (Si₃N₄), zirconium oxide (ZrO₂), titanium nitride (TiN), titanium oxide (TiO₂), titanium carbide (TiC), boron carbide (B₄C), tungsten carbide (WC), tungsten (W), and a tungsten carbide-cobalt (WC-Co) alloy.

3. The mold as described in claim 1, wherein the press surface is aspheric.

4. A method for making a mold used for press-molding glass optical articles, comprising:
providing a mold base with a press surface;
producing a plasma in a vacuum chamber;
bombarding a target electrode containing carbon material with ions in the plasma and ejecting carbon atoms from the target electrode; and
depositing the carbon atoms onto the press surface;
thereby forming a thin layer of diamond like carbon on the press surface.

5. The method as described in claim 4, wherein the press surface is aspheric.

6. The method as described in claim 4, wherein the mold base is made of a material selected from the group consisting of silicon carbide (SiC), silicon (Si), silicon nitride (Si₃N₄), zirconium oxide (ZrO₂), titanium nitride (TiN), titanium oxide (TiO₂), titanium carbide (TiC), boron carbide (B₄C), tungsten carbide (WC), tungsten (W), and a tungsten carbide-cobalt (WC—Co) alloy.

7. The method as described in claim 4, wherein the vacuum chamber is evacuated to a pressure below 10⁻⁶ torr prior to producing the plasma.

8. The method as described in claim 7, wherein argon gas and hydrogen gas are introduced into the vacuum chamber prior to producing the plasma.

9. The method as described in claim 8, wherein a proportion of the hydrogen gas is in the range from 5% to 20% by volume.

10. The method as described in claim 7, wherein argon gas and methane gas are introduced into the vacuum chamber prior to producing the plasma.

11. The method as described in claim 10, wherein a proportion of the methane gas is in the range from 5% to 20% by volume.

12. The method as described in claim 4, wherein a depositing rate is in the range from 3.3 to 8.3 angstroms per seconds during the depositing step.

13. The method as described in claim 4, wherein a thickness of the thin film is in the range from 50 to 200 angstroms.
